(19) United States
(12) Patent Application Publication
(10) Pub. No.: US 2022/0001237 A1
(43) Pub. Date: Jan. 6, 2022

(54) SYSTEM AND METHOD FOR REAL-TIME ACTIVITY CLASSIFICATION AND FEEDBACK

(71) Applicant: INTELLISPORTS INC., Montreal (CA)

(72) Inventors: Jonathan GUILLEMETTE, Outremont (CA); Benjamin F. MATTES, Montreal (CA)

(21) Appl. No.: 17/290,004

(22) PCT Filed: Oct. 29, 2019
(86) PCT No.: PCT/CA2019/051530

§ 371 Date: Apr. 29, 2021

Related U.S. Application Data
(60) Provisional application No. 62/752,281, filed on Oct. 29, 2018.

(51) Int. Cl. A63B 24/00

(52) U.S. Cl. CPC A63B 24/0006; A63B 24/0062; A63B 2220/62; A63B 2220/30; A63B 2220/40

(57) ABSTRACT

A system and method for real-time activity classification and feedback are provided. Real-time activity-related sensor data is acquired from one or more motion sensing devices during performance of at least one physical activity. Using at least one intelligent processing technique, one or more movements executed as part of the at least one physical activity are identified based on the sensor data. At least one quality assessment is attributed to each of the one or more movements as identified using the at least one intelligent processing technique. Real-time feedback about the one or more movements is generated based on the at least one quality assessment and the feedback is rendered to an output device in real-time.

### CROSS REFERENCE TO RELATED APPLICATIONS

This patent application claims priority of U.S. provisional Application Ser. No. 62/752,281, filed on Oct. 29, 2018, the entire contents of which are hereby incorporated by reference.

### TECHNICAL FIELD

The present disclosure relates to the field of using sensed information to recognize activity, and more particularly to classifying a play activity and providing feedback thereon in real-time based on the sensed information.

### BACKGROUND OF THE ART

Intelligent play objects, such as balls, pucks, discs, and sticks, collect information about the movement of the play object. This information can be transmitted from the play object and analyzed to obtain information about the player's skills. However, the information collected and transmitted by these play objects is often insufficient to be used to adequately assess a player's skills. In addition, the correctional guidance that can be provided to the player is limited.

There is therefore room for improvement.

### SUMMARY

In accordance with a first broad aspect, there is provided a computer-implemented method for real-time activity classification and feedback. The method comprises, at a computing device, acquiring, from one or more motion sensing devices, real-time sensor data during performance of at least one physical activity, identifying, using machine learning techniques and based on the sensor data, one or more movements executed as part of the at least one physical activity, attributing, using machine learning techniques, at least one quality assessment to each of the one or more movements, and outputting, based on the at least one quality assessment, real-time feedback about the one or more movements.

In some embodiments, the method further comprises obtaining motion classification data responsive to identifying the one or more movements, and applying the at least one intelligent processing technique to the motion classification data to determine at least one key performance indicator associated with the one or more movements.

In some embodiments, the method further comprises assessing, using the at least one intelligent processing technique, whether the one or more movements are valid, responsive to determining that the one or more movements are valid, generating, using the at least one intelligent processing technique, the motion classification data indicative of the one or more movements as identified, and responsive to determining that the one or more movements are not valid, identifying, using the at least one intelligent processing technique, one of an invalid motion and a cheating motion and generating, using the at least one intelligent processing technique, the motion classification data indicative of the one of the invalid motion and the cheating motion.

In some embodiments, the at least one key performance indicator is determined for each one of a plurality of axes along which the one or more movements of the user are measured, the at least one key performance indicator comprising at least one of speed, distance, time, sweep, consistency, deviation, and behavior.

In some embodiments, identifying the one or more movements comprises using the at least one intelligent processing technique to identify, based on the sensor data, at least one a core motion of a user performing the at least one physical activity, a limb motion of the user during the at least one physical activity, and a motion of at least one play object manipulated by the user during the at least one physical activity.

In some embodiments, the sensor data is acquired from the one or more motion sensing devices comprising at least one accelerator and/or at least one gyroscope, the at least one accelerator configured to produce in real-time acceleration values indicative of an acceleration of the user during the at least one physical activity and the at least one gyroscope configured to produce in real-time rotation values indicative of rotation of a body of the user during the at least one physical activity.

In some embodiments, the sensor data is acquired from the one or more motion sensing devices comprising at least a first data collector and a second data collector, the first data collector secured to a limb of the user and configured to collect in real-time first data indicative of the limb motion and the second data collector secured to a core of the user and configured to collect in real-time second data indicative of the core motion.

In some embodiments, the sensor data is acquired from the one or more motion sensing devices comprising at least one data collector provided in a portable electronic device configured to be secured to a body of the user.

In some embodiments, the feedback is rendered to the at least one output device associated with the portable electronic device.

In some embodiments, the sensor data is acquired from the one or more motion sensing devices comprising at least one data collector provided in the at least one play object, the at least one data collector configured to collect in real-time the sensor data indicative of a displacement of the play object through space.

In some embodiments, a trained model is applied to the sensor data to identify the one or more movements, attribute the at least one quality assessment, and generate the real-time feedback.

In accordance with a second broad aspect, there is provided a system for real-time activity classification and feedback. The system comprises a processing unit and a non-transitory memory communicatively coupled to the processing unit and comprising computer-readable program instructions executable by the processing unit for acquiring, from one or more motion sensing devices, real-time sensor data during performance of at least one physical activity, identifying, using machine learning techniques and based on the sensor data, one or more movements executed as part of the at least one physical activity, attributing, using machine learning techniques, at least one quality assessment to each of the one or more movements, and outputting, based on the at least one quality assessment, real-time feedback about the one or more movements.

In some embodiments, the computer-readable program instructions are further executable by the processing unit for obtaining motion classification data responsive to identifying the one or more movements, and applying the at least one intelligent processing technique to the motion classification data to determine at least one key performance indicator associated with the one or more movements.

In some embodiments, the computer-readable program instructions are further executable by the processing unit for assessing, using the at least one intelligent processing technique, whether the one or more movements are valid, responsive to determining that the one or more movements are valid, generating, using the at least one intelligent processing technique, the motion classification data indicative of the one or more movements as identified, and responsive to determining that the one or more movements are not valid, identifying, using the at least one intelligent processing technique, one of an invalid motion and a cheating motion and generating, using the at least one intelligent processing technique, the motion classification data indicative of the one of the invalid motion and the cheating motion.

In some embodiments, the computer-readable program instructions are executable by the processing unit for determining the at least one key performance indicator for each one of a plurality of axes along which the one or more movements of the user are measured, the at least one key performance indicator comprising at least one of speed, distance, time, sweep, consistency, deviation, and behavior.

In some embodiments, the computer-readable program instructions are executable by the processing unit for identifying the one or more movements comprising using the at least one intelligent processing technique to identify, based on the sensor data, at least one a core motion of a user performing the at least one physical activity, a limb motion of the user during the at least one physical activity, and a motion of at least one play object manipulated by the user during the at least one physical activity.

In some embodiments, the one or more motion sensing devices comprise at least a first data collector and a second data collector, the first data collector secured to a limb of the user and configured to collect in real-time first data indicative of the limb motion and the second data collector secured to a core of the user and configured to collect in real-time second data indicative of the core motion.

In some embodiments, the one or more motion sensing devices comprise at least one data collector provided in a portable electronic device configured to be secured to a body of the user.

In some embodiments, the one or more motion sensing devices comprise at least one data collector provided in the at least one play object, the at least one data collector configured to collect in real-time the sensor data indicative of a displacement of the play object through space.

In accordance with a third broad aspect, there is provided a non-transitory computer readable medium having stored thereon program code executable by at least one processor for acquiring, from one or more motion sensing devices, real-time sensor data during performance of at least one physical activity, identifying, using machine learning techniques and based on the sensor data, one or more movements executed as part of the at least one physical activity, attributing, using machine learning techniques, at least one quality assessment to each of the one or more movements, and outputting, based on the at least one quality assessment, real-time feedback about the one or more movements.

### BRIEF DESCRIPTION OF THE DRAWINGS

Further features and advantages of the present invention will become apparent from the following detailed description, taken in combination with the appended drawings, in which:

FIG. 1 is a flowchart of a method for real-time activity classification and feedback, in accordance with an illustrative embodiment;

FIG. 2 is a schematic diagram illustrating a plurality of data collectors for collecting motion data, in accordance with an illustrative embodiment;

FIG. 3 is a flowchart of the step 104 of FIG. 1 of classifying user-generated motion in real-time, in accordance with an illustrative embodiment;

FIG. 4 is a flowchart of the step 106 of FIG. 1 of determining key performance indicators, in accordance with an illustrative embodiment;

FIG. 5 is a flowchart of the step 108 of FIG. 1 of qualifying user-generated motion, in accordance with an illustrative embodiment;

FIG. 6 is a flowchart of the step 110 of FIG. 1 of outputting real-time feedback about user-generated motion, in accordance with an illustrative embodiment;

FIG. 7 is a schematic diagram illustrating audio feedback being provided in real-time during a baseball pitch, in accordance with an illustrative embodiment;

FIG. 8 is a schematic diagram of a system for real-time activity classification and feedback, in accordance with an illustrative embodiment; and

FIG. 9 is a schematic diagram of an application running on the processor of FIG. 10.

It will be noted that throughout the appended drawings, like features are identified by like reference numerals.

### DETAILED DESCRIPTION

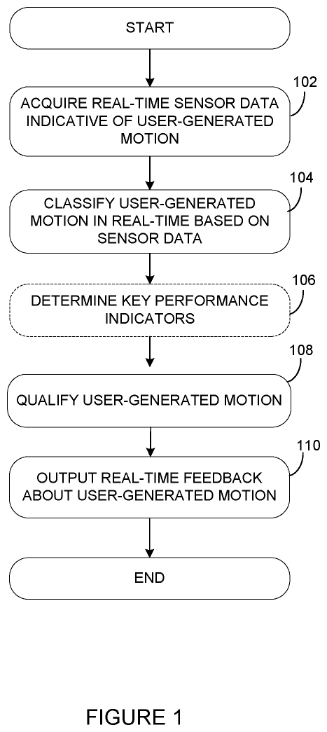

Referring to FIG. 1, a method 100 for real-time activity classification and feedback, in accordance with one embodiment, will now be described. As will be discussed further below, based on sensed information obtained from a plurality of sources and using a hierarchy of machine learning (ML) and/or artificial intelligence (AI) techniques or models (referred to herein as “intelligent processing techniques”), the method 100 may allow, in one embodiment, to recognize activity (e.g., human activity) in real-time and across a wide spectrum of movements and to provide real-time qualitative feedback on the movements.

A user (also referred to herein as a “player”) may indeed perform one or more movements (also referred to herein as “user-generated motion”) as part of a given physical activity (also referred to herein as a “play activity”), which may be any suitable activity including, but not limited to a sport activity. While the user is performing the play activity, sensor data (also referred to herein as “motion data”) is illustratively generated by multiple sources configured for collecting and transmitting data. At step 102, the sensor data is acquired from the various sources in real-time. As will be discussed further below, the acquired sensor data can then be analyzed (i.e. a trained model is applied thereto) to recognize and classify the user-generated motion being performed as well as provide feedback information about the user's skills, e.g. for evaluating user performance.

It should be understood that the ML and/or AI techniques described herein may comprise any suitable technique or model. Supervised machine learning using a classification or regression algorithm may apply. For instance, supervised learning algorithms and models including, but not limited to, support vector machines, discriminant analysis, naive Bayes, nearest neighbor, linear regression generalized linear models (GLM), Support Vector Regression (SVR), Gaussian Process Regression (GPR), ensemble methods, decision trees, and neural networks may be used.

In one embodiment, the ML and/or AI techniques described herein may comprise using a Long Short Term Memory Recurrent Neural Network (LSTM RNN) model that is trained and applied to the sensor data. As known to those skilled in the art, an RNN is a type of artificial neural network in which connections among units form a directed cycle. The RNN has an internal state that allows the network to exhibit dynamic temporal behavior. Unlike other neural networks, such as feed-forward neural networks for instance, RNNs can use their internal memory to process arbitrary sequences of inputs. An LSTM RNN further includes LSTM units, instead of, or in addition to, standard neural network units. An LSTM unit, or block, is a so-called “smart” unit that can remember, or store, a value for an arbitrary length of time. An LSTM block contains gates that determine when its input is significant enough to remember, when it should continue to remember or forget the value, and when it should output the value.

An LSTM RNN typically includes input nodes, blocks, or units; output nodes, blocks, or units; and hidden nodes, blocks, or units, with the input nodes corresponding to input data and the output nodes corresponding to output data as a function of the input data. First connections connect the input nodes to the hidden nodes and second connections connect the hidden nodes to the output nodes. In order to construct the LSTM RNN, training data (e.g., in the form input data that has been manually or otherwise already mapped to output data) is provided to a neural network model, which generates the hidden nodes, weights of the first connections between the input nodes and the hidden nodes, weights of the second connections between the hidden nodes and the output nodes, and weights of third connections between layers of hidden nodes. Thereafter, the LSTM RNN can be employed against input data for which output data is unknown.

Again, although the systems and methods for real-time activity classification and feedback are described herein as using LSTM RNN, it should be understood that any other suitable ML and/or AI technique may apply.

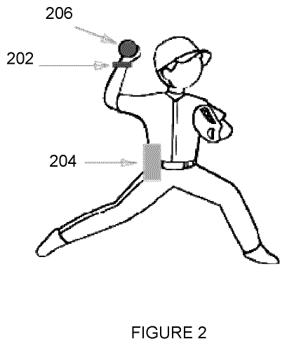

As illustrated in FIG. 2, in one embodiment, a plurality of independent data collectors 202, 204 (e.g., wearable sensing devices, such as fitness bracelets, fitness anklets, smart watches, headsets, or the like) may be provided at various locations on the user's body (or clothing) to continuously collect the motion data. For example, a first data collector 202 may be attached to a limb of the user to collect data indicative of the user's limb (e.g. arm) motion. Depending on the motion data to be collected, the first data collector 202 may be attached to any suitable limb of the user, such as an upper limb (e.g. wrist or arm) or a lower limb (e.g., ankle or leg). A second data collector 204 may be attached to the central part (or core) of the user's body in order to collect data indicative of motion of the user's core. For example, the second data collector 204 may be attached to the user's torso (e.g. hip). The data collectors 202, 204 may also be provided in a portable personal electronic device (e.g., a mobile phone, smart watch, or the like) of the user, the personal electronic device being secured to the user's body via suitable attachment means.

The data collectors 202, 204 may comprise any suitable motion sensing devices configured to measure movement and output corresponding signal(s) in real-time. For example, the data collectors 202, 204 include, but are not limited to, accelerometers and gyroscopes. The accelerometers may be configured to produce sensor signal(s) comprising acceleration values that describe the acceleration of the user's movement. The gyroscopes may be configured to produce sensor signal(s) comprising rotation values that describe the rotation of the user's movement. In particular, as used herein, the term “acceleration values” is understood to include acceleration vectors, as well as time derivatives/integrals of these values, such as speed and displacement. As used herein, the term “rotation values” is understood to include measurements of rotation (e.g. of the user's core or limb(s)), as well as time derivatives/integrals of these values.

In one embodiment, the user may perform the play activity using an object 206, referred to herein as a “play object”. The play object 206 illustratively has a coordinate system defined by three orthogonal axes of motion (namely an X axis, a Y axis, and a Z axis), three translational degrees of freedom in which it is displaced, and three rotational degrees of freedom about which it rotates. The three translational degrees of freedom are displacement movements of the play object 206 along the X, Y, and Z axes. In general, the X and Y axes define movement along a horizontal plane, and the Z axis is vertically oriented and defines movement in a vertical direction. The three rotational degrees of freedom are rotational movements about the X, Y, and Z axes.

A data collecting unit (not shown) is illustratively disposed within a body of the play object 206. The data-collecting unit collects (e.g. using one or more accelerometers and/or gyroscopes) motion data related to the movement of the play object 206 and transmits (e.g., periodically) the motion data to another remote device or system (not shown) so that the motion data can be analysed to provide information on player performance. This motion data can vary and is data related to the displacement of the play object 206 about itself, through space, and in time. It will be appreciated that the data-collecting unit can also be operational when the play object 206 is stationary. In addition, it should be understood that the location of the data-collecting unit within the play object 206 can vary, depending on the type of play object 206 being used and on the nature of the motion data being collected.

The play object 206 is shown in the figures (e.g. in FIG. 2) and described herein as a connected baseball configured to collect and transmit motion data while in use. It should however be understood that the play object 206 can be any other suitable object or device used during sports or activities. The play object 206 can be any object or device which is manipulated, either directly or indirectly, by a user such that it undergoes movement. Some non-limiting examples of play objects as in 206 disclosed herein are a ball (soccer, football, baseball, softball, golf, lacrosse, cricket, bowling, etc.), a baseball bat, a hockey puck, a hockey stick, a boxing glove, a curling rock, and a disc (i.e. such as a Frisbee™). Therefore, reference herein to baseballs or skills associated with baseball does not limit the disclosed play object 206 to being only a baseball, or to being used only in the sport of baseball. In addition, it should be understood that the motion data may be collected from various locations on the user's body and/or the play object 206, using any suitable number of data collectors. As previously discussed, it should also be understood that the user need not perform the play activity using the play object 206 and that the systems and methods described herein are not limited to the use of a play object from which the motion data is obtained.

At step 104, the user-generated motion is then classified in real-time based on the sensor data acquired at step 104. In this manner, it becomes possible to recognize any particular movement being performed by the user, as will be discussed further below. Key performance indicators may then optionally be determined at step 106 in order to determine what performance characteristics can be measured about the movement(s) recognized at step 104. The user-generated motion is then qualified at step 108, according to what it means to perform a particular movement poorly or well. At step 110, real-time feedback about the user-generated motion is output, for example, to allow the user to determine how the previously-performed movement(s) can be improved.

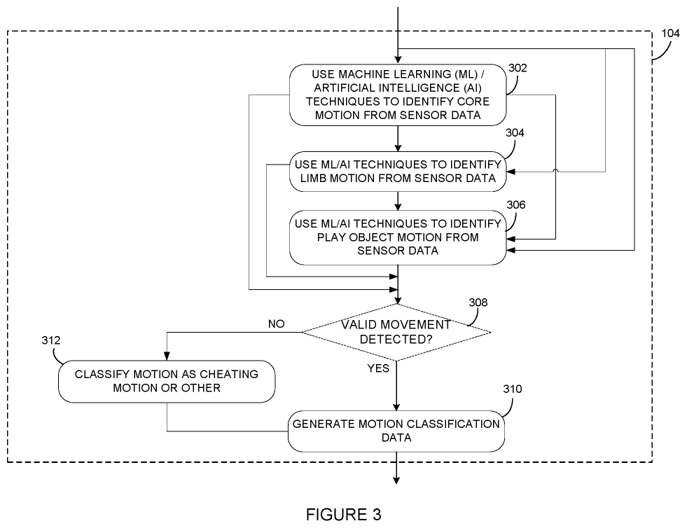

Referring now to FIG. 3, the step 104 of classifying the user-generated motion in real-time comprises identifying the specific motion performed by the user in real-time using ML and/or AI techniques. For instance, an LSTM RNN model may be trained to detect and differentiate between signal patterns within the sensor data acquired at step 102. In particular, the LSTM RNN may be used to differentiate between the various movements of the user (e.g., core motion versus limb motion) and/or the play object (reference 206 in FIG. 2), and more particularly to identify complex hybrid motions (e.g., user-generated movement(s), such as pitching, comprising hip motion that is tied to wrist motion to obtain a particular ball effect).

In one embodiment, ML and/AI techniques are first used at step 302 to identify the user's core motion based on the acquired sensor data. For example, using the LSTM RNN, the motion of the user's hips can be identified based on the data collected from the user's personal electronic device. Identification can illustratively be performed regardless of the specific location, spatial orientation, or model of the personal electronic device. In one embodiment, when the sensor data is acquired (at step 102 of FIG. 1) using the user's personal electronic device, the ML and/or AI may be trained such that the sensor data is collected from all locations where it is assumed that a user could place their personal electronic device. The ML and/or AI may also be trained to artificially modify the spatial orientation of the personal electronic device as well as all associated data in order to reduce the data gathering time. For example, the personal electronic device may be located at the user's waist and the data set gathered by the personal electronic device may be rotated to capture any desired degree variation around the user's waist. If one or more data collectors (e.g., attached to the user's wrist as discussed herein above) are also provided for collecting motion data related to the user's limb(s) (e.g., arm(s)), ML and/or AI techniques may additionally be used to identify limb motion based on the acquired sensor data at step 304. If one or more data collectors are also provided in the play object 206, ML and/or AI techniques may further be used at step 306 to identify the play object motion.

It should be understood that the steps 302, 304, and 306 may be performed in any order. It should also be understood that steps 302, 304, and 306 can be performed in conjunction or independently from one another and that one or more of these steps may be performed. For example, if the only available sensor data is the data collected from the user's personal electronic device, the user's core motion can be identified at step 302. In particular, the hip pivot evident in a baseball pitch may be detected at step 302 based on the collected sensor data and the user's motion can then be identified as a “Pitch”. If data is additionally collected from data collector(s) attached to a limb (e.g., arm) of the user, the pitch motion performed by the user can then be identified with more accuracy at step 304. If data is also collected from data collector(s) secured to the play object 206, the motion performed by the user can then be identified with additional precision (e.g., at step 306).

The next step 308 may then be to assess, based on the sensor data acquired at step 102, whether a valid movement has been detected. Performing the validation step 308 allows to detect user-generated movements that may look like a given play activity but are not (referred to herein as “cheating” motion). In one embodiment, step 308 comprises analyzing the sensor data using ML and/or AI techniques to assess whether the sensor data is indicative of a movement (referred to herein as a “valid” movement, e.g., a pitch, lunge, or push-up) similar (i.e. corresponding) to a given (e.g., required) play activity. For this purpose, the ML and/or AI techniques illustratively use one-to-one models trained to classify and recognize the unique digital signature of any given activity when using various data collectors.

If it is determined at step 308 that a valid movement has been detected (e.g. the required play activity has indeed been performed by the user and the correct motion has been detected), motion classification data indicative of the motion as identified at steps 302, 304, and/or 306 is then generated at step 310. It should be understood that a valid movement may be detected within a pre-determined tolerance. In other words, a movement performed by the user may be identified as valid provided it is within a pre-determined tolerance of a required movement. For example, the required movement may be a push-up whereby a user is required to lower his/her body by a pre-determined distance. If the user lowers his/her body by a distance that differs from the pre-determined distance but is within a given tolerance (e.g., 10%) thereof, the user's motion may still be detected as valid. In some embodiments, the motion classification data may also be output, e.g. rendered on any suitable output device for presentation of the information to the user.

If it is determined at step 308 that a valid movement is not detected, the user's motion may be classified as a cheating motion or other invalid motion (step 312). For example, if the play activity is a lunge (e.g., as identified from steps 302, 304, and/or 306) and the user attempts to fake the play activity by oscillating their personal electronic device up and down to generate corresponding motion data, this would be detected and classified as a cheating motion at step 312. In another example, if the user has been doing push-ups and then gets on their knees to take a break from the play activity, this would be classified as a motion (e.g. “standing”) other than a push-up or a cheating motion. The motion classification data is then generated at 310, the motion classification data indicating that the motion has either been identified as a cheating motion or another invalid motion. In one embodiment, detecting and distinguishing (using ML and/or AI models trained for this purpose) between correct (i.e. valid) motions, cheating motions (i.e. attempts to cheat the correct motion), and other invalid motions enables more precise classification of the user's movements. This in turn improves the overall accuracy of the systems and methods described herein by enabling to properly assess the user's skills and provide tailored feedback that address the uniqueness of the user's performance.

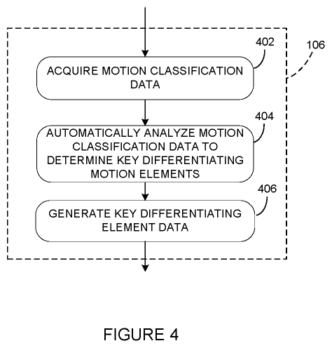

Referring now to FIG. 4, the step 106 of determining key performance indicators is optionally performed, depending on the complexity of the motion data acquired by the data collector(s) (at step 102 of FIG. 1). In one embodiment, step 106 comprises acquiring, at step 402, the motion classification data generated at step 310 of FIG. 3. The motion classification data is then automatically analyzed to determine key differentiating motion elements (step 404) associated with the user-generated motion. The key differentiating motion elements may include, but are not limited to, speed, distance, time, consistency, deviation, and behavior. In one embodiment, the key differentiating motion elements are defined for each one of the plurality of axes (i.e. X, Y, and Z axes) along which the user-generated motion is measured. In one embodiment, the key differentiating motion elements are determined by computing data (e.g., derivatives and/or integrals) that best highlights the motion being performed.

For example, if the motion being performed is a push-up, step 404 may comprise taking the double integral of the acceleration obtained from the sensor data in order to determine a distance traveled by the user (e.g. by the personal device) during the push-up. The distance may then be used as a key differentiating motion element that can be used to grade the push-up. Indeed, based on the computed distance, it becomes possible to determine whether the user has performed a deep or shallow push-up. If the motion being performed is a baseball pitch, step 404 may comprise calculating the integral of the rotation values obtained from the data collectors (i.e. gyroscopes) in order to obtain the angle swept by the user's hip movement. The angle may then be used as a key differentiating motion element that can be used to grate the pitch. Indeed, it may be possible to determine how much angular velocity the user had and for what period of time and to accordingly determine if the user threw the pitch with as much rhythm as usual (i.e. compared to previous pitches). Key differentiating element data is then generated accordingly at step 406. In some embodiments, the key differentiating element data may also be output, e.g. rendered on any suitable output device for presentation of the information to the user.

Continuing with the baseball pitching example, using only core motion data (acquired at step 402), step 404 may comprise identifying as key differentiating motion elements a number of critical indicators including, but not limited to, rotation speed along the Y axis, consistency along the X axis (i.e. a lack of side-to-side wiggle), and consistency along the Z axis (i.e. no up and down wiggle). If limb motion data is also available and acquired at step 402, step 404 may also identify as key differentiating motion elements additional critical indicators including, but not limited to, wrist velocity, wrist sweep (i.e. how large an arc the wrist follows during the pitch), wrist delay (i.e. how far into the hip rotation the wrist starts its arc), and wrist snap velocity (i.e. how fast the user snaps the wrist at the end of the pitch). If play object data is also available and acquired at step 402, step 404 may also identify as key differentiating motion elements additional critical indicators including, but not limited to, ball velocity and ball rotations.

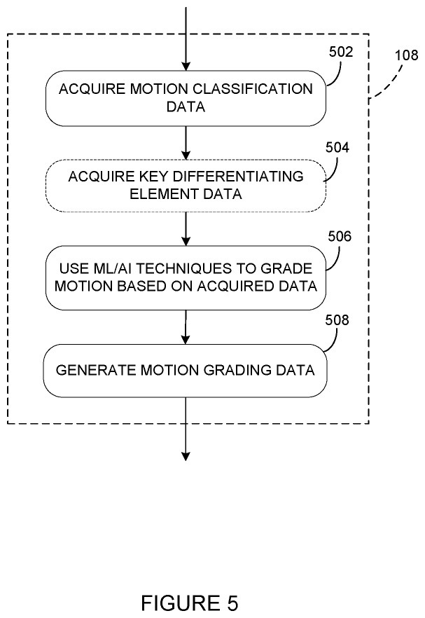

Referring now to FIG. 5, the step 108 of qualifying the user-generated motion comprises acquiring, at step 502, the motion classification data generated at step 310 of FIG. 3 and optionally acquiring (e.g., depending on the type of play activity and/or motion being performed by the user), at step 504, the key differentiating element data generated at step 406 of FIG. 4. ML and/or AI techniques (e.g., an LSTM RNN) are then illustratively used to grade the motion based on the acquired data (step 506). Motion grading data is then generated accordingly at step 508. In one embodiment, the motion grading data is generated in an array format. It should however be understood that other suitable formats may apply. In some embodiments, the motion grading data may also be output, e.g. rendered on any suitable output device for presentation of the information to the user.

In one embodiment, step 506 comprises using ML and/or AI techniques to classify each movement identified within the data acquired at step 502 as one of a number (N) of quality assessments. Step 506 illustratively uses the key differentiating motion elements identified and acquired at step 504. It should however be understood that, depending on the play activity and/or the motion being performed by the user, the ML and/or AI techniques may be trained to selectively use or not use the key differentiating element data for the classification and determine what category (e.g., good, medium or bad) the user-generated movement(s) match the most. For instance, for a motion such as a push-up for which a qualitative assessment (e.g., deep or shallow) is sufficient, the ML and/or AI techniques may do without the key differentiating element data and achieve the grading or classification (step 506) using the motion classification data only. For a more complex motion, such as a pitch, the ML and/or AI techniques may use the key differentiating element data to obtain a more complex classification.

The grading performed at step 506 may comprise computing a metric to determine how closely the motion corresponds to a given category and accordingly provide the quality assessment. For instance, continuing again with the push-up example, step 506 may comprise computing, for each of the deep and the shallow category, a numerical score. For example, the computation may determine that the push up corresponds to a deep push-up at 76% and to a shallow push-up at 24%, thus classifying or grading the push-up as “deep”.

Continuing again with the baseball pitching example, if only core motion data is available and acquired at step 502, step 506 may comprise assigning a numerical score (e.g., between zero (0) and one (1)) to each of the following four (4) possible pitch delivery categories:
(1) Fast, Stable (i.e. fast rotation along the Y axis, little deviation on the X or Z axis);
(2) Fast, Sloppy (i.e. fast rotation along the Y axis, significant deviation on the X or Z axis);
(3) Slow, Stable (i.e. slow rotation along the Y axis, little deviation on the X or Z axis); and
(4) Slow, Sloppy (i.e. slow rotation along the Y axis, significant deviation on the X or Z axis).

If limb motion data is also available and acquired at step 502, step 506 may comprise assigning a numerical score to each of the following sixteen (16) possible pitch deliveries:
(1) Fast waist, Stable waist, Matching Wrist Motion, Fast Wrist Snap (i.e. wrist motion follows the hip motion);
(2) Fast waist, Stable waist, Matching Wrist Motion, Slow Wrist Snap;
(3) Fast waist, Stable waist, Mis-aligned Wrist Motion, Fast Wrist Snap (i.e. wrist is offset from the hip motion);
(4) Fast waist, Stable waist, Mis-aligned Wrist Motion, Slow Wrist Snap;
(5) Fast waist, Sloppy waist, Matching Wrist Motion, Fast Wrist Snap;
(6) Fast waist, Sloppy waist, Matching Wrist Motion, Slow Wrist Snap;
(7) Fast waist, Sloppy waist, Mis-aligned Wrist Motion, Fast Wrist Snap;
(8) Fast waist, Sloppy waist, Mis-aligned Wrist Motion, Slow Wrist Snap;
(9) Slow waist, Stable waist, Matching Wrist Motion, Fast Wrist Snap;
(10) Slow waist, Stable waist, Matching Wrist Motion, Slow Wrist Snap;
(11) Slow waist, Stable waist, Mis-aligned Wrist Motion, Fast Wrist Snap;
(12) Slow waist, Stable waist, Mis-aligned Wrist Motion, Slow Wrist Snap;
(13) Slow waist, Sloppy waist, Matching Wrist Motion, Fast Wrist Snap;
(14) Slow waist, Sloppy waist, Matching Wrist Motion, Slow Wrist Snap;
(15) Slow waist, Sloppy waist, Mis-aligned Wrist Motion, Fast Wrist Snap; and
(16) Slow waist, Sloppy waist, Mis-aligned Wrist Motion, Slow Wrist Snap.

In this case, the motion grading data may be generated (step 508) as a 16-element array, with each element of the array corresponding to the numerical score, which is indicative of how close the pitch in question was to each of the sixteen possible deliveries listed above. An example array may be [0.6, 0.1, 0.01, 0.01, 0.2, 0.01, 0.01, 0.01, 0.01, 0.01, 0.01, 0.01, 0.007, 0.001, 0.001, 0.001], which corresponds to a pitch that is mostly “Fast waist, Stable waist, Matching Wrist Motion, Fast Wrist Snap” with some “Fast waist, Sloppy waist, Matching Wrist Motion, Fast Wrist Snap” present, even less “Fast waist, Stable waist, Matching Wrist Motion, Slow Wrist Snap” present, and all other possible deliveries in negligible quantities.

If play object data is also available and acquired at step 502, step 506 may comprise assigning a numerical score to an even greater number of (e.g. each of sixty-four (64)) possible pitch deliveries, which are not listed herein for the sake of conciseness. It will therefore be apparent that different movements may have different quality assessments, depending on the complexity of the movements being performed by the user and on which ones of the steps 302, 304, and 306 of FIG. 3 are implemented (i.e. on the available motion data).

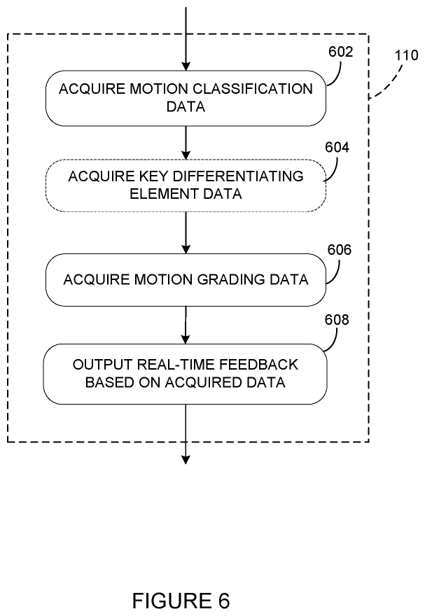

Referring now to FIG. 6, the step 110 of outputting real-time feedback about the user-generated motion allows to provide to the user real-time information about the movement(s) they completed as part of the play activity as well as information or instructions (e.g. guidance and advice) about what should be done by the user in their next movement(s) in order to improve their performance. In one embodiment, step 110 comprises acquiring, at step 602, the motion classification data generated at step 310 of FIG. 3, optionally acquiring, at step 604, the key differentiating element data generated at step 406 of FIG. 4, and acquiring, at step 606, the motion grading data generated at step 508 of FIG. 5. Real-time feedback is then output at step 608 based on the acquired data. For this purpose, the acquired data may be correlated against a database populated with correctional guidance information from experts, such as athletes and coaches. It should be understood that, depending on the play activity and/or the motion being performed by the user, only the motion grading data may be acquired (step 606). In particular, for a simple motion such as a push-up, the feedback may be provided at step 110 solely on the basis of the motion grading data. For a more complex motion, the motion classification data and the key differentiating element data may be needed in addition to the motion grading data to provide more detailed and in-depth feedback.

Continuing again with the baseball pitching example, if the motion grading data acquired at step 606 is the 16-unit array discussed above (i.e. [0.6, 0.1, 0.01, 0.01, 0.2, 0.01, 0.01, 0.01, 0.01, 0.01, 0.01, 0.01, 0.007, 0.001, 0.001, 0.001]), the feedback generated for this movement would inform the user that the pitch was mostly good form but that there was some deviation along the X and Z axes in the hips and that the wrist snap was not quite as fast as it ought to be. Correctional guidance information may also be output at step 110 to indicate to the user that they should pay attention to correcting hip stability and a faster wrist snap in the next pitch. It will however be appreciated that the examples given above of real-time feedback data (e.g., correctional guidance information) are not limiting, and that other types of such feedback data, from baseball as well as from other sports, are within the scope of the present disclosure.

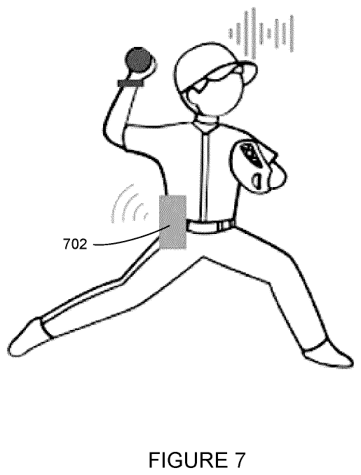

The feedback may be delivered in any suitable fashion. As illustrated in FIG. 7, the feedback may be delivered in real-time via audio generated by the user's personal electronic device 702 and broadcast to a headset or earpiece (not shown) worn by the user (and associated with the personal electronic device 702). Alternatively or in addition, the feedback may be displayed visually (e.g., in a graphical or non-graphical format), for instance on a screen of the user's personal electronic device. It should however be understood that the real-time feedback may also be provided to the user using any other suitable output means.

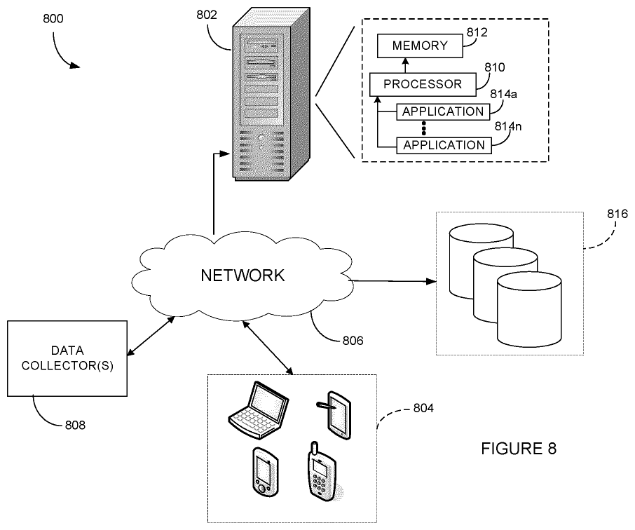

Referring now to FIG. 8, a system 800 for real-time activity classification and feedback, in accordance with one embodiment, will now be described. The system 800 may be used to analyze data generated by play activity (e.g., the motion data provided by a play object, as discussed herein above) in order to generate in real-time information related to player performance.

The system 800 may comprise one or more server(s) 802 adapted to communicate with a plurality of mobile devices 804 via a network 806, such as the Internet, a cellular network, Wi-Fi, or others known to those skilled in the art. The devices 804 may comprise any device, such as a laptop computer, a personal digital assistant (PDA), a tablet, a smartphone, or the like, adapted to communicate over the network 806. The system 800 may be installed on the devices 804 as a software application, which may be launched by the user on their device 804 (also referred to herein as a personal electronic device). Alternatively, access to the system 800 may be effected by the user logging on to a website, using any suitable access means. It should be understood that the system 800 may be accessed by multiple users simultaneously.

As will be discussed further below, the server 802 may receive motion data from one or more data collectors 808. In one embodiment, one or more data collectors 808 are provided in a play object held by a user when performing a given play activity. In another embodiment, the one or more data collectors are provided in (e.g., integrated with) a mobile device 804 (e.g., a smartphone) of the user.

In one embodiment, each data collector 808 is configured to measure movement (e.g. the movement of the play object and/or the movement of the user's mobile device 804) with one or more accelerometer units and one or more gyroscope units. Each data collector 808 may sample or collect data constantly, at discrete time intervals, and acquire measurements (i.e. acceleration and rotation values, or motion data) at any suitable frequency. In one embodiment, the acceleration and rotation values are measured at a relative high frequency. The measurements are then transmitted wirelessly, e.g. using a transmitting unit such as an antenna or transceiver. In some embodiments, the transmitting unit is a Bluetooth™ transmitter using low energy technology with minimal connection frequency. In some embodiments, the data collectors 808 are configured to process (e.g., encrypt, compress, reformat) the collected data prior to transmission thereof.

The server 802 may comprise a series of servers corresponding to a web server, an application server, and a database server. These servers are all represented by server 802 in FIG. 8. The server 802 may comprise, amongst other things, a processor 810 coupled to a memory 812 and having a plurality of applications 814a, . . . , 814n running thereon. The processor 810 may access the memory 812 to retrieve data. The processor 810 may be any device that can perform operations on data. Some non-limiting examples of the processor 810 include a microcontroller, a central processing unit (CPU), a front-end processor, a microprocessor, a graphics processing unit (GPU/VPU), a physics processing unit (PPU), a digital signal processor, and a network processor. The applications 814a, . . . , 814n are coupled to the processor 810 and configured to perform various tasks as explained below in more detail. It should be understood that while the applications 814a, . . . , 814n presented herein are illustrated and described as separate entities, they may be combined or separated in a variety of ways. It should be understood that an operating system (not shown) may be used as an intermediary between the processor 810 and the applications 814a, . . . , 814n.

The memory 812 accessible by the processor 810 may receive and store data. In particular, the memory 812 stores motion data (e.g. the acceleration and rotation values produced and transmitted by the data collector(s) 808). As the motion data is analysed by the processor 810, or upon being prompted, the memory 812 can be rewritten or modified to store therein new data. For instance, the memory 812 may store motion classification data, key differentiating element data, grading data, and/or feedback data, as discussed herein above. The memory 812 may therefore be a main memory, such as a high speed Random Access Memory (RAM), or an auxiliary storage unit, such as a hard disk or flash memory. The memory 812 may be any other type of memory, such as a Read-Only Memory (ROM), Erasable Programmable Read-Only Memory (EPROM), or optical storage media such as a videodisc and a compact disc. Also, although the system 800 is described herein as comprising the processor 810 having the applications 814a, . . . , 814n running thereon, it should be understood that cloud computing may also be used. As such, the memory 812 may comprise cloud storage.

One or more databases 816 may be integrated directly into the memory 812 or may be provided separately therefrom and remotely from the server 802 (as illustrated). In the case of a remote access to the databases 816, access may occur via any type of network 806, as indicated above. The databases 816 described herein may be provided as collections of data or information organized for rapid search and retrieval by a computer. The databases 816 may be structured to facilitate storage, retrieval, modification, and deletion of data in conjunction with various data-processing operations. The databases 816 may consist of a file or sets of files that can be broken down into records, each of which consists of one or more fields. Database information may be retrieved through queries using keywords and sorting commands, in order to rapidly search, rearrange, group, and select the field. The databases 816 may be any organization of data on a data storage medium, such as one or more servers. As discussed above, the system 800 may use cloud computing and it should therefore be understood that the databases 816 may comprise cloud storage.

In one embodiment, the databases 816 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). Identity verification of a user may be performed using usernames and passwords for all users. Various levels of access authorizations may be provided to multiple levels of users.

The processor 810 is illustratively in communication with each one of the data collectors 808, via a suitable transmitting unit or system transceiver. The processor 810 can therefore receive motion data from each data collector 808, as previously mentioned. The processor 810 may also emit instructions to each data collector 808. For example, the processor 810 can command all of the data collectors 808 to produce motion data along one or more of the X, Y, and Z axes. The processor 810 may send signals to deactivate one or more data collectors 808. The processor 810 may also configure each of the data collectors 808, so as to change, for example, the frequency at which the acceleration values are measured. In addition, the processor 810 may instruct the memory 812 to store the motion data (e.g., acceleration and/or rotational values) for a predetermined period of time corresponding to a specific play activity.

The processor 810 may communicate directly with the data collector(s) 808, or indirectly via the server 802 or the network 806. Furthermore, the system 800 may have a signal concentrator (not shown) in communication with the data collector(s) 808 and with the processor 810. The signal concentrator may aggregate or concentrate the motion data (e.g. the acceleration and rotation values) emitted by the data collector(s) 808, and then relay this concentrated signal data to the processor 810. Any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

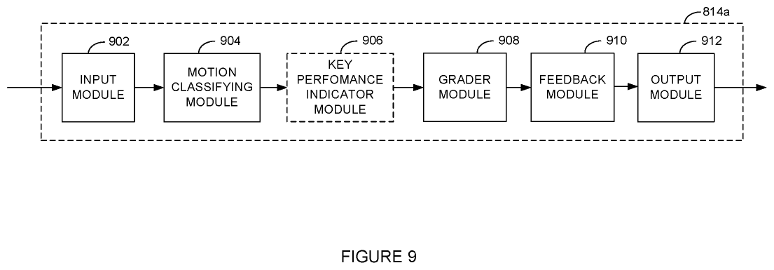

FIG. 9 is an exemplary embodiment of an application 814a running on the processor 810 of FIG. 8. The application 814a illustratively comprises an input module 902, a motion classifying module 904, an optional key performance indicator module 906, a grader module 908, a feedback module 910, and an output module 912. At least the motion classifying module 904 and the grader module 908 may be implemented using ML and/or AI techniques, e.g. using a trained LSTM RNN model, as discussed herein above.

The input module 902 illustratively receives one or more input signals from the one or more device(s) 804 and/or the data collector(s) 808, the input signals indicative of the motion data, as discussed herein above. The motion classifying module 904 classifies the user's movement(s), based on the motion data, by implementing the steps of the method described above with reference to FIG. 3. The key performance indicator module 906 then determines key performance indicators, by implementing the steps described above with reference to FIG. 4. The grader module 908 is then used to implement the steps described above with reference to FIG. 5 in order to qualify the user's movement(s). The feedback module 910 then outputs feedback about the user's movement(s) in real-time, according to the steps described above with reference to FIG. 6.

The modules 904, 906, 908, and 910 may then each output their outcome (e.g. motion classification data, key differentiating element data, grading data, feedback data) to the output module 910 for presentation of the information to the users, e.g. rendering on a suitable output device, including but not limited to a speaker, screen, or the like, that may or may not be associated with the user's device 804. The information may also be transmitted to the device 804 through instant push notifications sent via the network 806. Email, Short Message Service (SMS), Multimedia Messaging Service (MMS), instant messaging (IM), or other suitable communication means.

In one embodiment, using the methods and systems described herein may allow to ensure that, during a play activity, a user is not only doing the movement(s) they are supposed to, but also that the user is doing the movement(s) correctly. In particular, employing a trained model in activity classification and feedback may advantageously improve the accuracy of the motion classification and play activity grading processes performed on the acquired sensor data. Using the systems and methods described herein, it may then become possible, contrary to conventional activity (e.g., exercise) assistance systems, to provide, in real-time, feedback (e.g., correctional guidance) that addresses the particularities of an individual user's performance of a physical activity. As such, the techniques disclosed herein provide a technical improvement to activity recognition technology.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, and/or on a computer readable medium. The embodiments of the invention described above are intended to be exemplary only. The scope of the invention is therefore intended to be limited solely by the scope of the appended claims.

1. A computer-implemented method comprising, at a computing device:
acquiring, from one or more motion sensing devices, real-time activity-related sensor data during performance of at least one physical activity;
identifying, using at least one intelligent processing technique and based on the sensor data, one or more movements executed as part of the at least one physical activity;
attributing, using the at least one intelligent processing technique, at least one quality assessment to each of the one or more movements as identified; and
generating, based on the at least one quality assessment, real-time feedback about the one or more movements and rendering the feedback to at least one output device in real-time.

2. The method of claim 1, further comprising obtaining motion classification data responsive to identifying the one or more movements, and applying the at least one intelligent processing technique to the motion classification data to determine at least one key performance indicator associated with the one or more movements.

3. The method of claim 2, further comprising:
assessing, using the at least one intelligent processing technique, whether the one or more movements are valid;
responsive to determining that the one or more movements are valid, generating, using the at least one intelligent processing technique, the motion classification data indicative of the one or more movements as identified; and
responsive to determining that the one or more movements are not valid, identifying, using the at least one intelligent processing technique, one of an invalid motion and a cheating motion and generating, using the at least one intelligent processing technique, the motion classification data indicative of the one of the invalid motion and the cheating motion.

4. The method of claim 2, wherein the at least one key performance indicator is determined for each one of a plurality of axes along which the one or more movements of the user are measured, the at least one key performance indicator comprising at least one of speed, distance, time, sweep, consistency, deviation, and behavior.

5. The method of claim 1, wherein identifying the one or more movements comprises using the at least one intelligent processing technique to identify, based on the sensor data, at least one of a core motion of a user performing the at least one physical activity, a limb motion of the user during the at least one physical activity, and a motion of at least one play object manipulated by the user during the at least one physical activity.

6. The method of claim 5, wherein the sensor data is acquired from the one or more motion sensing devices comprising at least one accelerator and/or at least one gyroscope, the at least one accelerator configured to produce in real-time acceleration values indicative of an acceleration of the user during the at least one physical activity and the at least one gyroscope configured to produce in real-time rotation values indicative of rotation of a body of the user during the at least one physical activity.

7. The method of claim 5, wherein the sensor data is acquired from the one or more motion sensing devices comprising at least a first data collector and a second data collector, the first data collector secured to a limb of the user and configured to collect in real-time first data indicative of the limb motion and the second data collector secured to a core of the user and configured to collect in real-time second data indicative of the core motion.

8. The method of claim 5, wherein the sensor data is acquired from the one or more motion sensing devices comprising at least one data collector provided in a portable electronic device configured to be secured to a body of the user.

9. The method of claim 8, wherein the feedback is rendered to the at least one output device associated with the portable electronic device.

10. The method of claim 5, wherein the sensor data is acquired from the one or more motion sensing devices comprising at least one data collector provided in the at least one play object, the at least one data collector configured to collect in real-time the sensor data indicative of a displacement of the play object through space.

11. The method of claim 1, wherein a trained model is applied to the sensor data to identify the one or more movements, attribute the at least one quality assessment, and generate the real-time feedback.

12. A system comprising:
one or more motion sensing devices configured to generate activity-related sensor data in real-time during performance of at least one physical activity;
a processing unit communicatively connected to the one or more motions data; and
a non-transitory memory communicatively coupled to the processing unit and comprising computer-readable program instructions executable by the processing unit for:
acquiring the sensor data in real-time from the one or more motion sensing devices;
identifying, using at least one intelligent processing technique and based on the sensor data, one or more movements executed as part of the at least one physical activity;
attributing, using the at least one intelligent processing technique, at least one quality assessment to each of the one or more movements as identified; and
generating, based on the at least one quality assessment, real-time feedback about the one or more movements and rendering the feedback to at least one output device in real-time.

13. The system of claim 12, wherein the computer-readable program instructions are further executable by the processing unit for obtaining motion classification data responsive to identifying the one or more movements, and applying the at least one intelligent processing technique to the motion classification data to determine at least one key performance indicator associated with the one or more movements.

14. The system of claim 13, wherein the computer-readable program instructions are further executable by the processing unit for:
assessing, using the at least one intelligent processing technique, whether the one or more movements are valid;
responsive to determining that the one or more movements are valid, generating, using the at least one intelligent processing technique, the motion classification data indicative of the one or more movements as identified; and
responsive to determining that the one or more movements are not valid, identifying, using the at least one intelligent processing technique, one of an invalid motion and a cheating motion and generating, using the at least one intelligent processing technique, the motion classification data indicative of the one of the invalid motion and the cheating motion.

15. The system of claim 13, wherein the computer-readable program instructions are executable by the processing unit for determining the at least one key performance indicator for each one of a plurality of axes along which the one or more movements of the user are measured, the at least one key performance indicator comprising at least one of speed, distance, time, sweep, consistency, deviation, and behavior.

16. The system of claim 12, wherein the computer-readable program instructions are executable by the processing unit for identifying the one or more movements comprising using the at least one intelligent processing technique to identify, based on the sensor data, at least one of a core motion of a user performing the at least one physical activity, a limb motion of the user during the at least one physical activity, and a motion of at least one play object manipulated by the user during the at least one physical activity.

17. The system of claim 16, wherein the one or more motion sensing devices comprise at least a first data collector and a second data collector, the first data collector secured to a limb of the user and configured to collect in real-time first data indicative of the limb motion and the second data collector secured to a core of the user and configured to collect in real-time second data indicative of the core motion.

18. The system of claim 16, wherein the one or more motion sensing devices comprise at least one data collector provided in a portable electronic device configured to be secured to a body of the user.

19. The system of claim 16, wherein the one or more motion sensing devices comprise at least one data collector provided in the at least one play object, the at least one data collector configured to collect in real-time the sensor data indicative of a displacement of the play object through space.

20. A non-transitory computer readable medium having stored thereon program code executable by at least one processor for:
acquiring, from one or more motion sensing devices, real-time activity-related sensor data during performance of at least one physical activity;
identifying, using at least one intelligent processing technique and based on the sensor data, one or more movements executed as part of the at least one physical activity;
attributing, using the at least one intelligent processing technique, at least one quality assessment to each of the one or more movements; and
generating, based on the at least one quality assessment, real-time feedback about the one or more movements and rendering the feedback to at least one output device in real-time.
